(19) United States
(12) Patent Application Publication
(10) Pub. No.: US 2003/0204598 A1
(43) Pub. Date: Oct. 30, 2003

(54) Method and arrangement for controlling interconnection between cable modem devices and multiple cable modem termination systems

(76) Inventors: Louis Dominick Bifano, Morrisville, PA (US); William Blum, Harleysville, PA (US); Jeffrey Ollis, Harleysville, PA (US)

Correspondence Address: Wendy W. Koba, Esq., PO Box 556, Springtown, PA, 18081, US

(21) Appl. No.: 10/132,241

(22) Filed: Apr. 25, 2002

(51) Int. Cl. G06F 15/16

(52) U.S. Cl. 709/227

(57) ABSTRACT

A system and method for ensuring communication between a subscriber and the proper CMTS in a multiple CMTS system utilizes a user-defined option in the DHCP DISCOVER and OFFER commands used to initialize service. A cable modem that is requesting connection to a CMTS will include a particular, user-defined option in its DISCOVER command. If the receiving DHCP server recognizes the user-defined option, it will send a modified version of the option back to the cable modem in its OFFER command, and the cable modem will establish the interconnection. If the receiving DHCP server does not recognize the user-defined option, it will send a conventional OFFER command back to the cable modem. Since the cable modem will be expecting to receive the modified user-defined option, it will reject the conventional OFFER command, thereby avoiding the connection of the cable modem to the improper cable modem termination system.

### TECHNICAL FIELD

The present invention relates to provisioning the interconnection between a cable modem and a cable modem termination system (CMTS) in an environment where there are multiple CMTSs on hybrid fiber-coax (HFC) communication path.

### BACKGROUND OF THE INVENTION

With the explosive growth of the Internet, many cable system customers have desired to use the larger bandwidth of a cable television network to connect to the Internet and other computer networks. Cable modems offer these customers higher speed connectivity, supporting a data connection to these networks with a data rate of up to 30+ Mbps, a significant increase over the data rate that can be supported with a conventional serial telephone line.

However, most cable television networks provide unidirectional cable systems, supporting only a downstream data path from the cable system headend to the customer. A cable system headend is defined as a central location in the cable television network that is responsible for sending cable signals in the downstream direction to the subscriber. A few cable system operators, however, are beginning to include the capability to send “upstream” communication from the customer into the network, a truly bi-directional cable system. A cable television system with an upstream connection is often referred to as a “data-over-cable system”.

In providing such communication, a cable modem termination system (CMTS) receives data packets from the data network and transmits them downstream via the cable network to a cable modem coupled to the customer premise equipment (e.g., a customer's computer). The customer premise equipment sends response data packets upstream via the cable modem, which in turn sends the packets via the HFC network to the CMTS. The CMTS is able to identify the receptor of the upstream data packets and then forwards the packets to the proper host on the data network.

As a cable modem is initialized in a data-over-cable system, it registers with a CMTS to allow the cable modem to receive and transmit data in a proper format. In particular, the cable modem forwards to the CMTS all of the configuration information that it has received from the customer premise equipment during installation as part of a registration request. A cable modem may also help initialize and register with the CMTS any attached customer premise equipment.

A CMTS in a data-over-cable system typically manages connections to thousands of cable modems. Most of the cable modems are attached to host customer premise equipment, such as a customer computer. To send and receive data to and from a computer network like the Internet or an intranet, a cable modem and customer premise equipment (as well as other network devices) require the use of a network address that is dynamically assigned on the data-over-cable system. Many data-over-cable systems use the Dynamic Host Configuration Protocol (“DHCP”) as a standard messaging protocol to dynamically allocate network addresses, such as Internet Protocol (“IP”) addresses. As is known in the art, DHCP is a protocol for passing configuration information to communication devices on a network. The Internet Protocol is an addressing protocol designed to route traffic within a network, or between networks.

As a cable modem is initialized, it will obtain a network address such as an IP address with DHCP and send this network address to the CMTS. The CMTS stores the network address for that particular cable modem in an internal configuration table. When customer premise equipment attached to the cable modem is initialized, it will also obtain a network address, such as an IP address. The network address for the customer premise equipment is stored in an internal table in the cable modem. The network address for the customer premise equipment is also stored on the CMTS with the network address associated with its cable modem. When data arrives for the customer premise equipment from the Internet or the like, the CMTS uses its internal table to route the data to the proper customer premise equipment. A network address from the data will be used to compare with network addresses from the internal tables on the CMTS.

A problem arises when there are multiple CMTSs on the same HFC segment, each CMTS capable of communicating with the various cable modems on that segment. In particular, each network access provider (NAP) uses its own CMTS, which should only communicate with those cable modems that have subscribed to that particular network access provider. Moreover, each CMTS is most likely not “aware” of the presence of other CMTSs on the same communication link. As a result, a customer premise equipment may become connected to the wrong CMTS, be inadequately provisioned, and end up utilizing bandwidth reserved for subscribers' customer premise equipment.

Thus, a need remains in the art to ensure the proper interconnection between customer premise equipment and the appropriate CMTS when there are multiple cable modem termination systems on the same communication link.

### SUMMARY OF THE INVENTION

The need remaining in the prior art is addressed by the present invention, which relates to provisioning the interconnection between a cable modem and a cable modem termination system (CMTS) in an environment where there are multiple CMTSs on an HFC segment.

In accordance with the present invention an initial “handshake” procedure is used between the subscriber interface device (e.g., cable modem or multi-media terminal adapter (MTA) unit) and a CMTS. The handshake comprises a user-defined option included in an initialization message sent by the subscriber device to a network element used to establish connection with a CMTS. The network element can then respond to the user-defined option with a modification, sending the modified option back to the subscriber device. The subscriber device is configured to recognize the presence of the modified offer in the response message and will then accept connection to the associated CMTS. If the network element does not respond to the user-defined option, the subscriber device will not connect to the CMTS associated with that network element.

In a preferred embodiment which utilizes a DHCP server as the network element, the DHCP “DISCOVER” and “OFFER” messages are enhanced with the user-defined option, where a DHCP server with the user-defined option will only respond to a DHCP DISCOVER message that contains the proper user-defined option. Otherwise, the DHCP server will deny the request. Similarly, the subscriber device is configured to only accept OFFER messages from a DHCP server containing the user-defined option.

Other and further aspects of the present invention will become apparent during the course of the following discussion and by reference to the accompanying drawings.

### BRIEF DESCRIPTION OF THE DRAWINGS

Referring now to the drawings,

FIG. 1 illustrates an exemplary network environment for deploying the interconnection technique of the present invention;

FIG. 2 contains a table of exemplary user-defined values that can be employed by a DHCP server and cable modem in utilizing the technique of the present invention;

FIG. 3 is an object interaction diagram (OID) illustrating the message flow associated with an enhanced cable modem utilizing the user-defined DISCOVER option of the present invention;

FIG. 4 is an object interaction diagram (OID) illustrating the message flow associated with a conventional cable modem, illustrating in particular its inability to communicate with a DHCP server including the user-defined DISCOVER option of the present invention.

### DETAILED DESCRIPTION

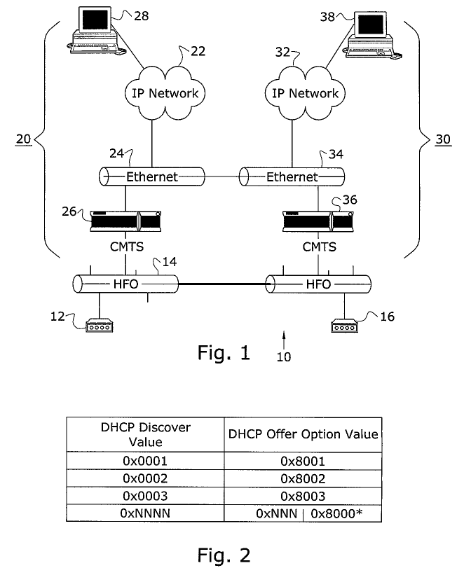

FIG. 1 illustrates an exemplary hybrid fiber coax (HFC) network 10 that may be used to implement the user-defined interconnect procedure between customer premise equipment and multiple cable modem termination systems. As shown, a conventional cable modem 12 (i.e., a modem without the inventive capability of defining the interconnection to a specific CMTS) is illustrated as coupled to an HFC segment 14 in network 10. A multi-media terminal adapter (MTA) unit 16 is configured to implement the user-defined support option of the present invention and is also connected to HFC segment 14. It is to be understood that the use of the terms “cable modem” and “multimedia terminal adapter” are interchangeable and are further considered to be examples of the general area of “subscriber communication interface” devices. That is, any device located at or near a communication endpoint that is used to provide connection of cable and telephone connections between the endpoint and the network. During the course of the present discussion, both the terms “cable modem” and “MTA” will be used, but should be considered as merely examples of specific subscriber communication interface devices.

As discussed above, it has become a common occurrence (which will only become more prevalent) to have more than one network access provider supporting data communication over a common HFC segment (such as segment 14 in FIG. 1). In the arrangement as shown in FIG. 1, a first network access provider 20 comprises an IP network 22, an Ethernet connection 24 and a cable modem termination system 26. CMTS 26 is coupled to HFC segment 14 and functions to communicate with the various customer premise equipment connected through cable modems and MTAs to HFC segment 14. A DHCP server 28, used to store allocated network addresses for connected subscriber devices, is shown as in communication with IP network 22. A second network access provider 30 is also illustrated in FIG. 1, and includes a separate IP network 32, Ethernet connection 34, cable modem termination system 36 and DHCP server 38. As shown, CMTS 36 is also in communication with HFC segment 14, and is therefore also capable of establishing a communication path with the various cable modems and MTAs along HFC segment 14.

In the prior art, when there was more than one CMTS in communication with devices along the same HFC segment, confusion could result regarding the appropriate interconnection of the cable modems/MTAs and the CMTSs. In the arrangement as shown in FIG. 1, for example, cable modem 12 could end up being improperly connected to IP network 30 through CMTS 36, where the correct connection would be through CMTS 26 to first network access provider 20.

In accordance with the present invention, therefore, the messages transmitted between a cable modem and the DHCP server upon initialization have been modified to include a user-defined option which is sent by the cable modem to the server. If the DHCP server has been enhanced to include the proper response to the user-defined option, initialization will continue. Alternatively, if the server does not recognize this user-defined option, the cable modem will not accept the offer of service from the DHCP server, and will use another downstream frequency and attempt an initialization process with another DHCP server. Also, if a DHCP server is “waiting” for such a user-defined option from a cable modem and none is forthcoming (such as will be the case with prior art, unmodified cable modems), further initialization will also be terminated. In general, proper interconnection between cable modems and the appropriate CMTS will occur in accordance with the present invention by both units including and utilizing a user-defined option with the DHCP initialization messages.

In particular, a communication unit such as MTA 16 is enhanced to include a user-defined option in the DHCP DISCOVER message (the initialization message broadcast over HFC segment 14 by MTA 16 to “find” a CMTS with which to connect). In the arrangement illustrated in FIG. 1, MTA 16 is intended to communicate with CMTS 36 belonging to second network access provider 30. Therefore, DHCP server 38 is also enhanced to only respond to DHCP DISCOVER messages that contain the user-defined option. The response from DHCP server 38 to MTA 16 is in the form of an OFFER message include a modified version of the user-defined option. Accordingly, MTA 16 is configured to only respond to a CMTS which transmits an OFFER message including the appropriately modified option value.

FIG. 2 includes a table illustrating various DHCP DISCOVER values that may be used by devices such as MTA 16, and the associated modifications as made by their partner CMTS, in terms of the reply OFFER option value. In general, the option in the DISCOVER message is bit-wise logically OR'd with the value 0×8000 to form the modified reply OFFER message. This is considered to be an exemplary arrangement only; various agreed-upon sets of DISCOVER and OFFER messages may be used to provide the proper interconnection in accordance with the present invention. Further, it is to be understood that, in general, any appropriate “handshake” (i.e., exchange of signals) between a subscriber interface device and a network element responsible for establishing communication may be used. The use of the DHCP server is exemplary only, but considered as a preferred embodiment of practicing the present invention.

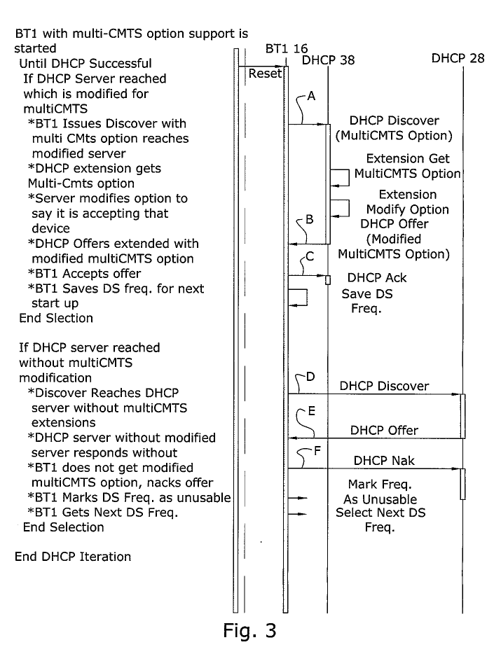

FIG. 3 is an object interaction diagram illustrating the message flow associated with an enhanced cable modem utilizing the user-defined DISCOVER option of the present invention, in this case MTA 16. Shown in the message flow of FIG. 3 are alternative attempts to interconnect with both DHCP server 38 (enhanced to include the user-defined option) and DHCP server 28 (a conventional, prior art DHCP server). The communication sequence begins with initializing an MTA with the “multi-CMTS option”, such as MTA 16, to interconnect with a suitable DHCP server. In software terms, the process begins with the step “until DHCP successful”, and then proceeds to link up the proper interconnection between MTA 16 and a cable modem termination system (CMTS). Referring to the first group of steps in the sequence, it is presumed that the first DHCP server reached is “modified for multi-CMTS” (such as DHCP server 38). The process begins with MTA 16 issuing a DISCOVER command including the user-defined option, which reaches DHCP server 38, as shown along path A in FIG. 3. DHCP server 38 then retrieves this option from a table, such as that shown in FIG. 2, and modifies the option to indicate that it is accepting connection to MTA 16, extending this modified option as an OFFER message back to MTA 16, as shown along path B in FIG. 3. MTA 16 then accepts this connection offer and sends an acknowledgement of the acceptance back to DHCP server 38 (path C in FIG. 3). MTA 16 then saves, in an internal table, the downstream frequency associated CMTS 36, where this information may be used the next time MTA 16 restarts, avoiding the need for this interconnection process.

In an alternative process stream, also illustrated in FIG. 3, it can be presumed that the first DHCP server reached by MTA 16 does not include the multi-CMTS option (such as, for example, DHCP server 28). Path D in FIG. 3 illustrates the initial communication attempt between MTA 16 and DHCP server 28, where the DISCOVER command from MTA 16 will include the user-defined multi-CMTS option of the present invention. In this case, DHCP server 28 does not recognize this option and merely responds with a prior art, conventional OFFER command (path E). MTA 16, upon receiving this OFFER response determines that the proper modified option (as shown in FIG. 2), is not included in the OFFER and therefore does not accept interconnection with CMTS 26, as shown by the “nak” response sent to DHCP server 28 (path F). MTA 16 then marks the particular downstream frequency associated with CMTS 26 as “unusable”, and obtains another downstream frequency to use to attempt to interconnect with the proper CMTS. The process then loops through each step, and will continue until the MTA receives the proper modified option value in the OFFER response.

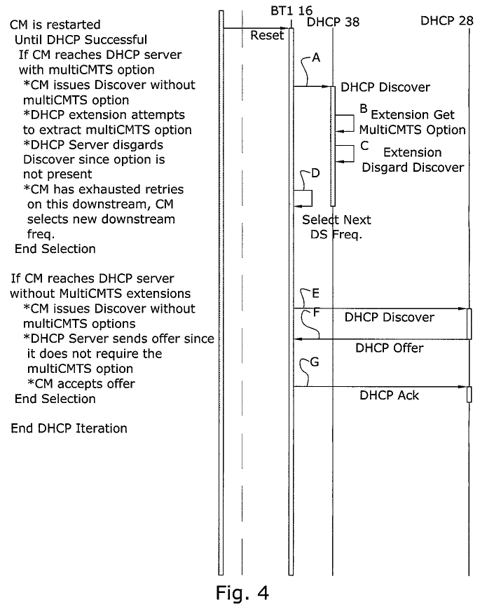

It is also possible for a conventional cable modem without the inventive user-defined option (such as cable modem 12) to attempt an interconnection with a CMTS that has been configured to accept and acknowledge the user-defined option (such as CMTS 36). FIG. 4 illustrates, in an object interaction diagram, the message flows associated with the interconnection attempts of a conventional cable modem, such as cable modem 12 of FIG. 1. As with the process described above in association with FIG. 3, the software steps accompanying this process begins with the command “until DHCP successful”, then performing the following steps until cable modem 12 is connected to the proper CMTS (in this case, CMTS 26). The first set of steps in FIG. 4 illustrate the attempt of cable modem 12 to establish communication with a CMTS including the userdefined multi-CMTS option (such as CMTS 36). The process begins with cable modem 12 transmitting a conventional DISCOVER command to DHCP 38 (path A in FIG. 4). DHCP 38 attempts to extract the user-defined option it requires to establish a communication path with a cable modem/MTA (loop B in FIG. 4). Since such an option is not found, DHCP 38 disregards this DISCOVER command (loop C). Having not received a response, cable modem 12 then selects another downstream frequency to use to attempt an interconnection with the proper CMTS (loop D).

At some point in time along the process, cable modem 12 will select a downstream frequency associated with CMTS 26, a conventional CMTS that does not use the user-defined option, the selection beginning with cable modem 12 sending a conventional DISCOVER command to DHCP server 28 (path E in FIG. 4). DHCP server 28, a conventional prior art DHCP server, then sends a conventional OFFER command to cable modem 12 (path F), which is then acknowledged by cable modem 12 (path G) and the service is established.

It should be noted that the various programs, processes, systems and apparatus described herein are exemplary only, and the utilization of a user-defined option to establish connection between a subscriber interface device and the proper CMTS may take any suitable form. For example, the steps in the sequence diagrams may be other than those described, and include more or fewer elements. Moreover, the inclusion of the user-defined option in the DHCP DISCOVER and OFFER commands is considered to be exemplary only, other “handshake” commands may be exchanged between the subscriber interface device and a network initialization element to establish the connection to the proper CMTS in accordance with the present invention. Indeed, the embodiment of the present invention as illustrated and described is not intended to limit all possible forms of the invention. Rather, the words used in the specification are considered to be terms of description rather than limitation, and it is understood that various changes may be made without departing from the spirit and scope of the present invention.

What is claimed is:

1. In a data-over-cable communication system including a plurality of separate cable modem termination systems distributed along a single communication path, with a plurality of subscriber communication interface devices coupled to said single communication path, a method for establishing communication between each one of said subscriber communication interface devices with its proper cable modem termination system, the method comprising the steps of:
a) transmitting a user-defined option in an initialization command sent by a subscriber communication interface device to a network element used to establish communication with a cable modem termination system;
b) receiving, at the network element, the user-defined option;
c) searching for said user-defined option in an initialization database at said network element and, if found,
generating a modification thereto;
transmitting the modified user-defined option in a response initialization command to the subscriber interface device; and
accepting, at the subscriber interface device, the modified user-defined option in the response initialization command and establishing a communication path with said cable modem termination system, defined as the proper cable modem termination system;
and if not found;
d) selecting, at the subscriber interface device, another network element for attempting interconnection with a proper CMTS;
e) transmitting the user-defined option in an initialization command sent by a the subscriber communication device to the next selected network element; and
f) continuing steps b) and c) until the proper cable modem termination system is found.

2. The method as defined in claim 1 wherein the network element used to establish communication comprises a DHCP server.

3. The method as defined in claim 2 wherein in performing step a), the initialization command comprises a DHCP DISCOVER command and the user-defined option is included in the DHCP DISCOVER command.

4. The method as defined in claim 2 wherein in performing step c), the response initialization command comprises a DHCP OFFER command and the modified user-defined option is included in the DHCP OFFER command.

5. In a data-over-cable communication system including a plurality of cable modem termination systems distributed along a single communication path, with a plurality of subscriber communication interface devices coupled to said communication path, an arrangement for establishing communication between each one of said subscriber interface devices and its proper cable modem termination system, the arrangement comprising
an initialization element included in a subscriber interface device for generating a user-defined option incorporated in an initialization command and sending said user-defined option to a network element utilized to establish a communication link between a cable modem termination system and said subscriber interface device; and
a response arrangement included in the network element for recognizing said user-defined option and generating a modified user-defined option for transmission to the subscriber interface device in a response initialization command, wherein in the absence of either a user-defined option or a modified user-defined option a communication link will not be established between the subscriber interface device and the cable modem termination system.

6. The arrangement as defined in claim 5 wherein the network element comprises a DHCP server.

7. The arrangement as defined in claim 6 wherein the initialization command comprises a DHCP DISCOVER command.

8. The arrangement as defined in claim 6 wherein the response initialization command comprises a DHCP OFFER command.
